(19) United States
(12) Patent Application Publication
(10) Pub. No.: US 2020/0205616 A1
(43) Pub. Date: Jul. 2, 2020

(54) LIQUID FLOW MOLDS AND RELATED METHODS

(71) Applicant: NS INDUSTRIES LLC, Brooklyn, NY (US)

(72) Inventor: Noah SCHARF, Brooklyn, NJ (US)

(21) Appl. No.: 16/731,923

(22) Filed: Dec. 31, 2019

Related U.S. Application Data
(60) Provisional application No. 62/786,824, filed on Dec. 31, 2018.

(51) Int. Cl. A47J 43/20; A23P 30/10

(52) U.S. Cl. CPC A47J 43/20; A21D 13/44; A23P 30/10

(57) ABSTRACT

Liquid flow molds and related methods are disclosed. According to an aspect, a liquid flow mold or device includes a peripheral mold wall defining a peripheral boundary and a maximum fill height. The device also includes a plurality of exclusion volumes offset from the mold wall within the peripheral boundary. Further, the device includes a plurality of locator members connecting the volumes with respect to the mold wall, extending in a plane proximate the maximum fill height, defining the locations of the volumes within the boundary; and a plurality of canal members connecting the volumes and defining a canal formation height that is lower than the maximum fill height.

### CROSS-REFERENCE TO RELATED APPLICATION

The present application is related to and claims priority from U.S. Provisional Application Ser. No. 62/786,824, filed Dec. 31, 2018, which application is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### TECHNICAL FIELD

At least some embodiments disclosed herein relate, in general, to pourable molds, and more specifically to food-safe molds, pancake molds, and other devices and methods associated therewith.

### BACKGROUND

The prior art of pancakes and other relevant fields contemplate forming pourable materials into substantially planar shapes of consistent section throughout a height. Pancakes are disproportionately practiced for the benefits of being a high-quantity and/or high calorie breakfast item minimum of steps, minimum required tools, speed of preparation and uniformity of outcome without requiring high precision, and ability to be scaled to accommodate an unpredictable quantity of demand. Essentially, they became popular by being well suited to volume production at a wide-variety of preparation venues, for working adults on limited budget and high physical demands. The pancake, consistent with such alternate names as “flapjack,” is historically conjured as an item served to a physical laborer having a large appetite or need for calories, on a limited budget.

However, with familiarity and proliferation beyond and for several of these benefits, pancakes have been adapted from a volume production for adults having needs for quantity or quantity per dollar and thereafter adults attracted to the image of someone having a life with such demands to a newer context, that of being a fun treat made for a child. The simple minimum preparation and low complexity for execution of acceptable quality, when relieved of the need for maximum quantity and/or maximum quantity per unit time, allows pancakes to be augmented with additional steps, in order to maximize fun. Practiced pouring allows for flow-based shapes to be formed with overlaps of round spreads of poured batter, but this desired end condones use of forms by molds or other physical boundaries, like casting molds or wall molds or waffle irons, for example, that allow for greater regularity of fun shapes, despite adding a step and/or quantity of tools, because it exchanges skill and even perhaps likelihood of unacceptable quality for regularity of successful preparation of a fun shape, even though it does forego the spontaneity that otherwise might have been available by preparation without a fixed form.

In several of such pancakes formed by a constraining form or mold, the end result can have voids within the pancakes, which are fun because they allow versatility in producing shapes like faces that have prominent features like eyes or mouths, without adding items to the pancake, to evoke these features. In the case of such pancakes, however, syrup poured thereon has the tendency to run-off of the surface and pool within the voids, rather than seep into the cake, and/or absorb disproportionately into the cake with proximity to these voids. Currently, often individuals do not utilize the hollow area of their designs in pancakes, nor do they utilize their pancake syrup in any fun way.

Therefore, it is desirable to conceive of solutions which expand the opportunities for novel fun in formation of pancakes with voids, with respect to utilizing syrup with the play, preparation, or consumption or quality benefits of the pancake.

### SUMMARY

Several disclosed embodiments are exemplary of the present invention but should not be construed as unduly limiting upon the invention as claimed. Those described are illustrative in order to teach novel devices and methods that support the matter claimed and adequately enable practice at least a few exemplary contemplated embodiments thereof.

For example, while the background of the problem, rooted in pancakes, gave rise to several embodiments depicted here that are still of specific benefit to pancakes, the net result is not limited to specifically pancakes. Several embodiments identified are functional to novel benefit with other materials used for filling a mold and with respect to receiving liquids that are not necessarily syrup, and therefore the detailed description and claims and the overall value of the matters disclosed herein should not be limited to merely pancake batter except as specifically recited. Speaking broadly then, are aspects of the invention which are exemplary of several embodiments:

According to an aspect, a device embodiment comprising a peripheral mold wall defining a peripheral boundary and a maximum fill height; a plurality of exclusion volumes offset from the mold wall within the peripheral boundary; a plurality of locator members connecting the volumes with respect to the mold wall, extending in a plane proximate the maximum fill height, defining the locations of the volumes within the boundary; and a plurality of canal members connecting the volumes and defining a canal formation height that is lower than the maximum fill height. Such a device embodiment contemplates that pouring a fill material into the device to a fill height that is greater than the canal formation height and less than the maximum fill height defines a contiguous fixable unit of material having a periphery in the shape of the peripheral boundary; window voids in the material at the locations of the exclusion volumes through the entire height of the unit and having canals extending between the voids through the amount of the height which is between the canal formation height and the fill height.

According to an another aspect, a method of forming a unit of poured fill material, comprising several steps: defining a peripheral boundary and a maximum fill height with a peripheral mold wall; offsetting a plurality of exclusion volumes from the mold wall within the peripheral boundary; connecting the volumes with respect to the mold wall and defining the locations of the volumes within the boundary with a plurality of locator members, ex-tending in a plane proximate the maximum fill height; and connecting the volumes and defining a canal formation height that is lower than the maximum fill height with a plurality of canal members. Thereafter, pouring a fill material into the device to a fill height that is greater than the canal formation height and less than the maximum fill height to define a contiguous fixable unit of material having a periphery in the shape of the peripheral boundary; window voids in the material at the locations of the exclusion volumes through the entire height of the unit and having canals ex-tending between the voids through the amount of the height which is between the canal formation height and the fill height.

### BRIEF DESCRIPTION OF THE DRAWINGS

The embodiments are illustrated by way of example and not limitation in the figures of the accompanying drawings in which like references indicate similar elements.

FIG. 1 shows a perspective view of an embodiment of a pancake mold embodiment having a butterfly shaped mold wall in accordance with the present disclosure.

FIG. 2 shows a perspective view of an embodiment of a pancake mold embodiment having a butterfly shaped mold wall with canal members in accordance with the present disclosure.

FIG. 3 shows a perspective view of an embodiment of a pancake mold embodiment having a heart shaped mold wall in accordance with the present disclosure.

FIG. 4 shows a perspective view of an embodiment of a pancake mold embodiment having a heart shaped mold wall with canal members in accordance with the present disclosure.

FIG. 5 shows a perspective view of an embodiment of a pancake mold embodiment having a truck shaped mold wall in accordance with the present disclosure.

FIG. 6 shows a perspective view of an embodiment of a pancake mold embodiment having a truck shaped mold wall with canal members in accordance with the present disclosure.

FIG. 7 shows a perspective view of an embodiment of a pancake mold embodiment having a sun shaped mold wall in accordance with the present disclosure.

FIG. 8 shows a perspective view of an embodiment of a pancake mold embodiment having a sun shaped mold wall with canal members in accordance with the present disclosure.

FIGS. 9A-B shows side elevation views of an embodiment of a pancake mold embodiment having a truck shaped mold wall with canal members in accordance with the present disclosure.

FIG. 10 shows a perspective view of the underside of a truck-shaped unit of pourable material formed by a pancake mold embodiment having a truck shaped mold wall with canal members in accordance with the present disclosure.

FIGS. 11A-D show perspective views of the top sides of truck-shaped units of pourable material formed by a pancake mold embodiment having a truck shaped mold wall with canal members in accordance with the present disclosure.

FIG. 11E shows a perspective view of an embodiment of a pancake mold embodiment having a truck shaped mold wall with canal members, which is configured to produce a unit of pourable material similar to the unit shown in FIG. 11D, in accordance with the present disclosure.

FIG. 11F shows a close perspective views of the top sides of a truck-shaped unit of pourable material formed contemporaneously by a pancake mold embodiment having a truck shaped mold wall with exclusion volumes that comprise island formation volumes, in accordance with the present disclosure.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

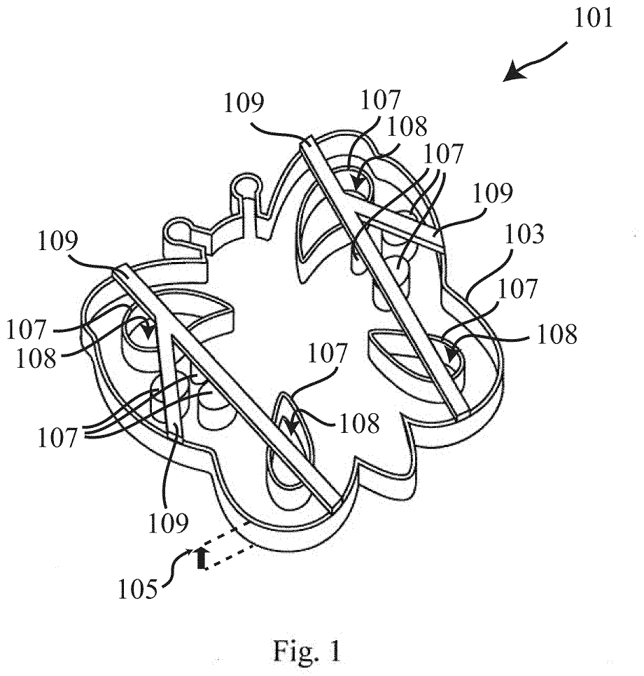

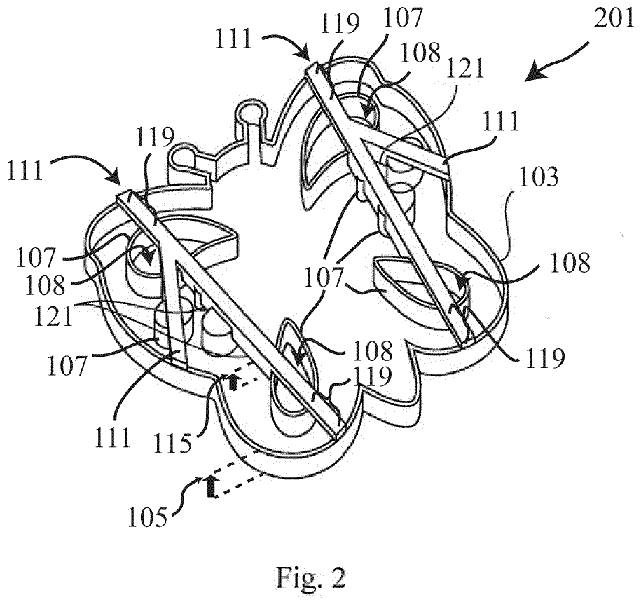

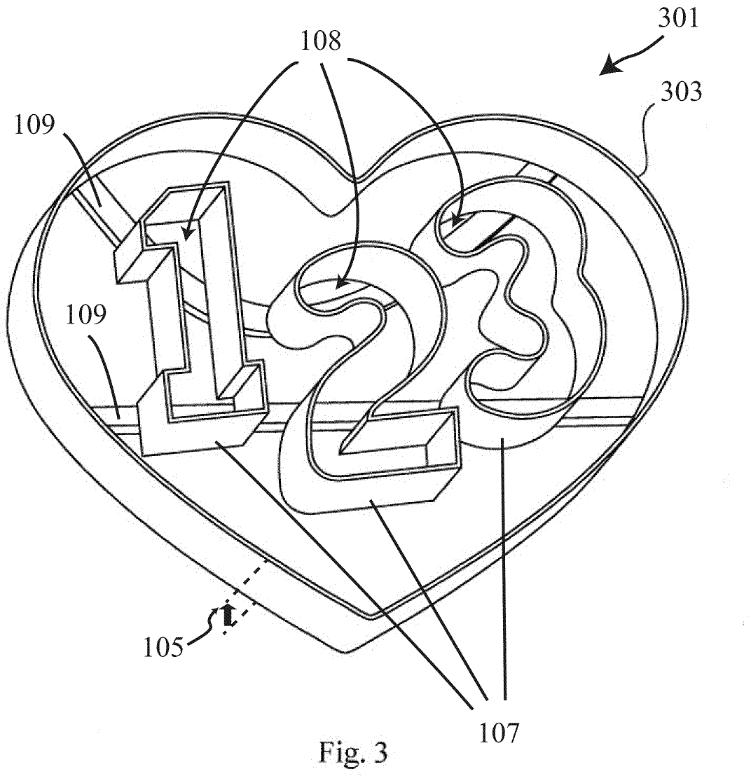

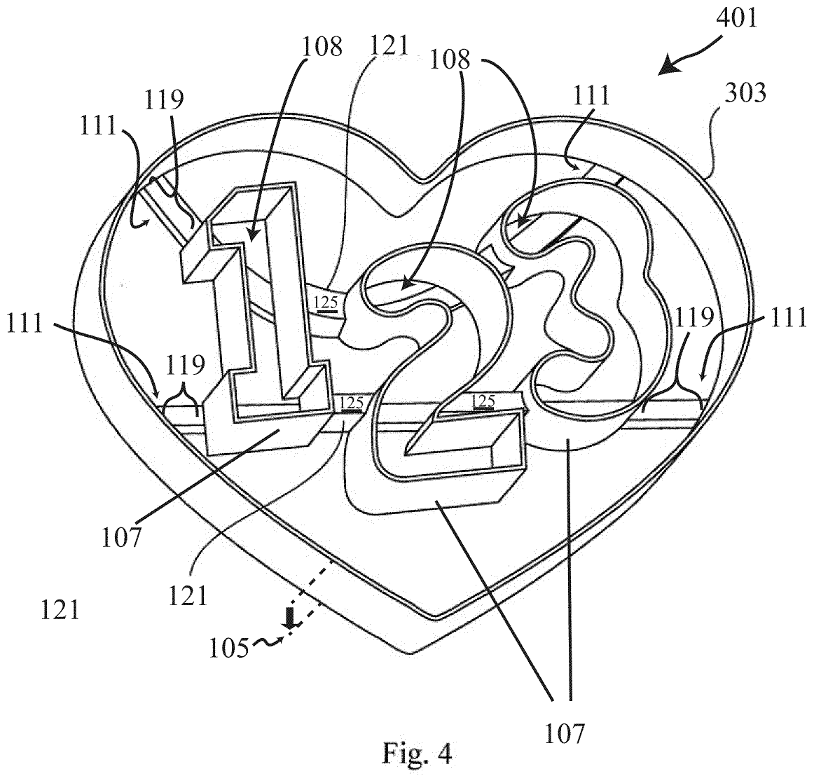

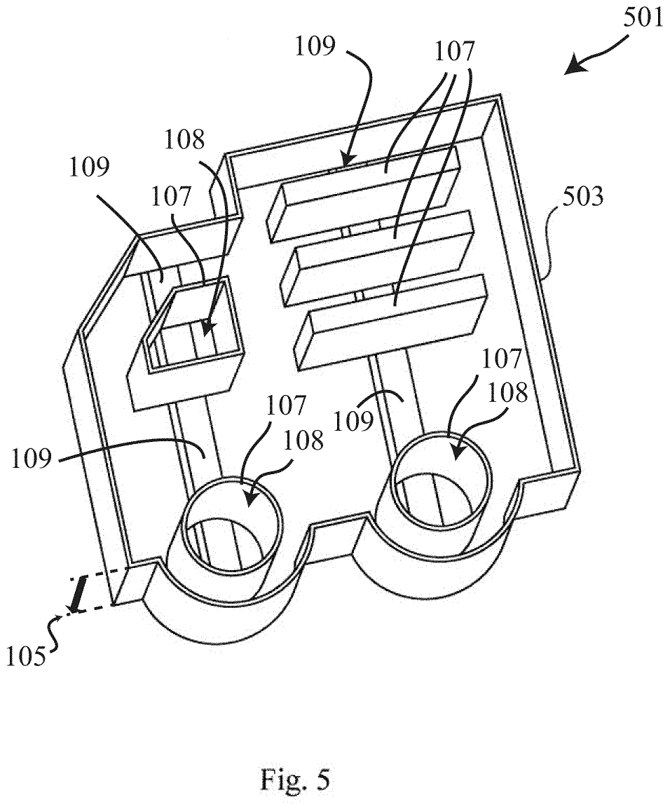

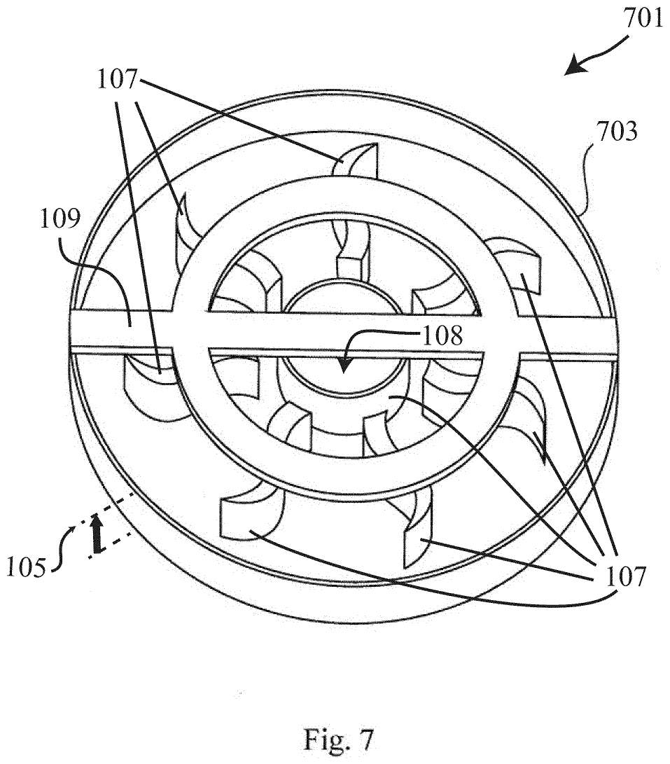

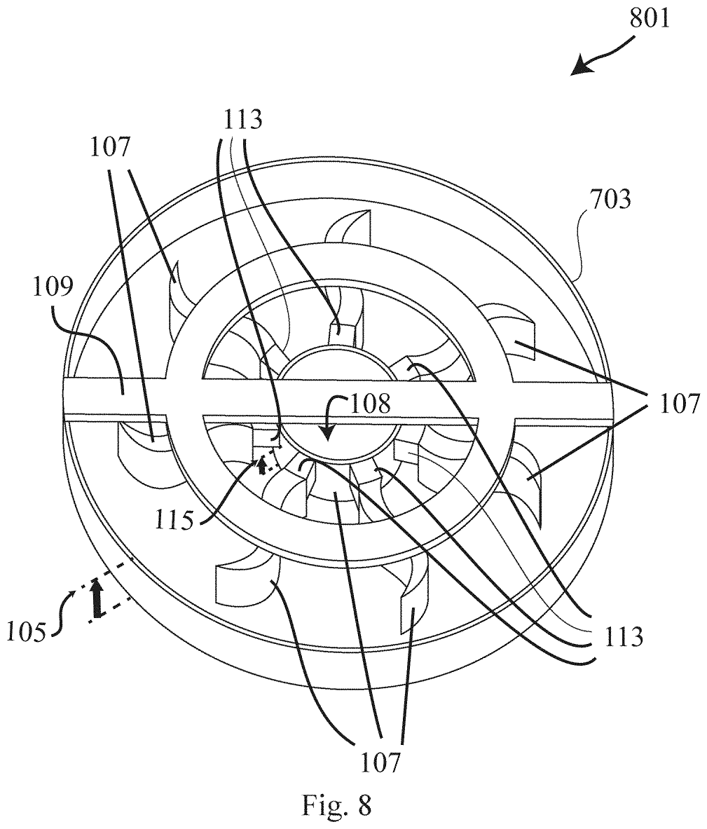

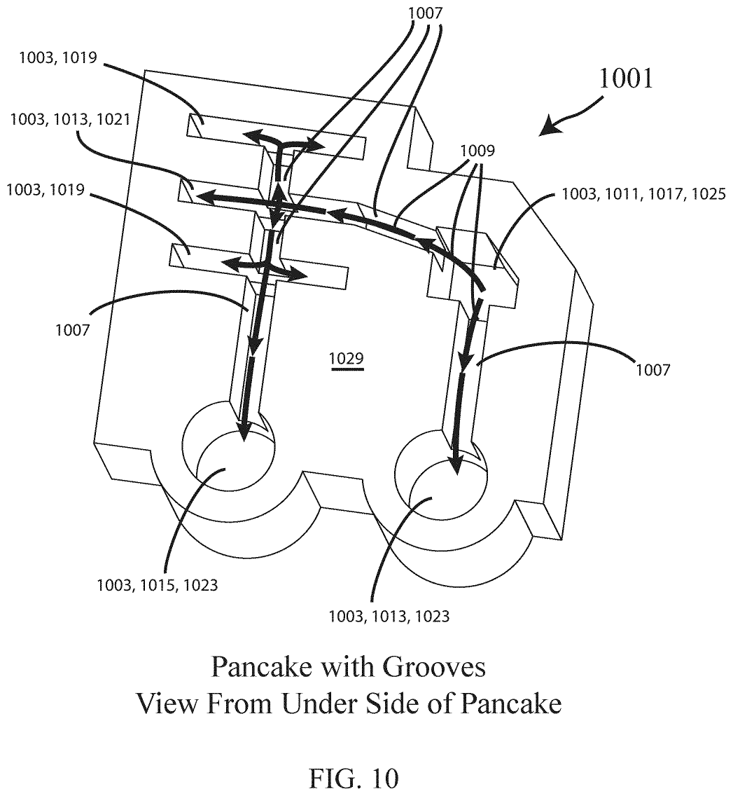

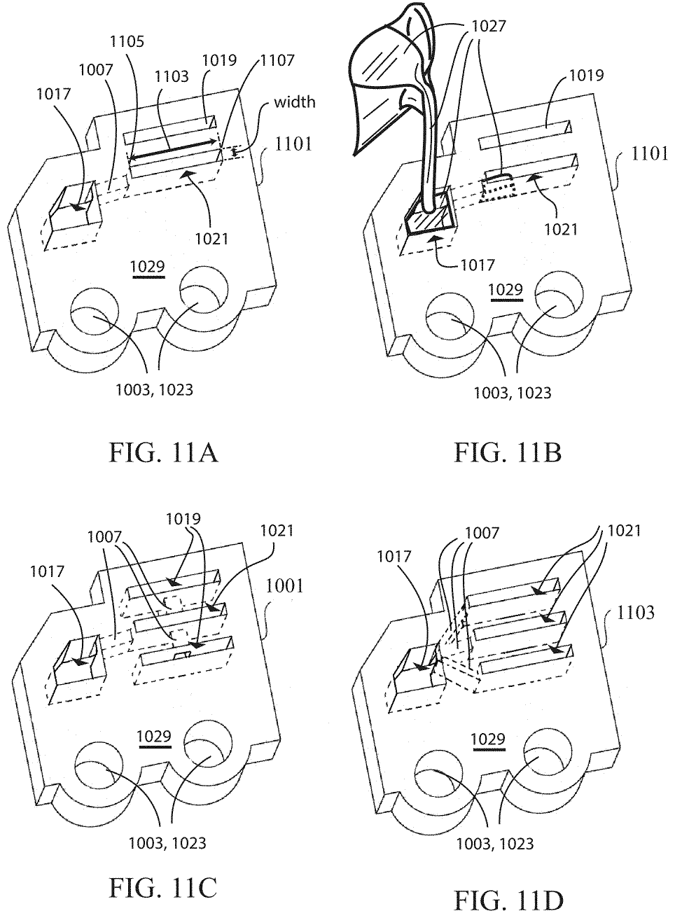

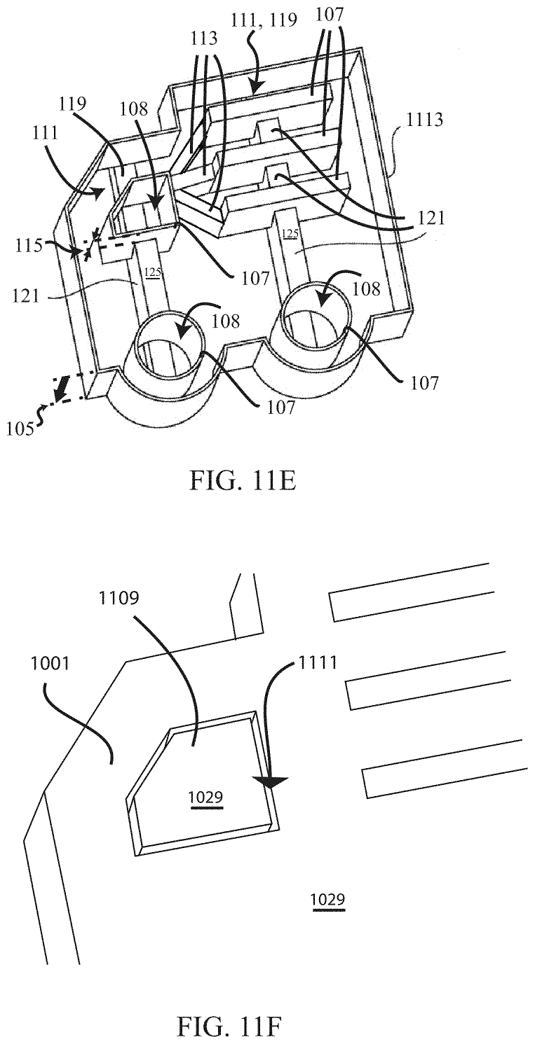

Referring now to FIGS. 1-8 and 9A-B, what are shown are perspective views and side elevation views, respectively, of an exemplary pancake molds of the present invention. By having respectively shaped butterfly-, heart-, truck-, and sun-shaped mold walls 103, 303, 503, 703, FIGS. 1-2 show butterfly shaped molds 101 and 201, FIGS. 3-4 show heart shaped molds 301 and 401, FIGS. 5-6 and 9A-B show truck shaped molds 501 and 601, and FIGS. 7-8 show sun-shaped molds 701. These molds produce units of fill material that have a top side (units 1101,1001,1103, FIGS. 11A-D) and a bottom side (1001, FIG. 10), but the molds are considered to be “right side up” (See FIGS. 1,2, 7, 8, 9B) in an arrangement that is opposite to the direction of the “top side” of unit, when it is formed therein.

In each of these figures, the mold walls 103 define a peripheral boundary of the same size and shape and a maximum fill height 105; a plurality of exclusion volumes 107 offset from the mold wall 103 within the peripheral boundary. There are a plurality of locator members 109 and combined members 111 connecting the volumes 107 with respect to the mold wall 103, extending in a plane proximate the maximum fill height 105. The locator members 109 and combined members 111 define the locations of the respective volumes 107 within the boundary.

The embodiments shown in FIGS. 2, 4, 6, 8 (and 9A-B) also comprise a plurality of canal members 113. Canal members 113 and combined members 111 connect the volumes 107 and define a canal formation height 115 that is lower than the maximum fill height 105. With respect to combined members 111, note that these are “combined” insofar as they provide the functions of both locator members and canal members by comprising canal-member-like portions 121 at inter-volume locations (portions between volumes 107) on the locator members 109.

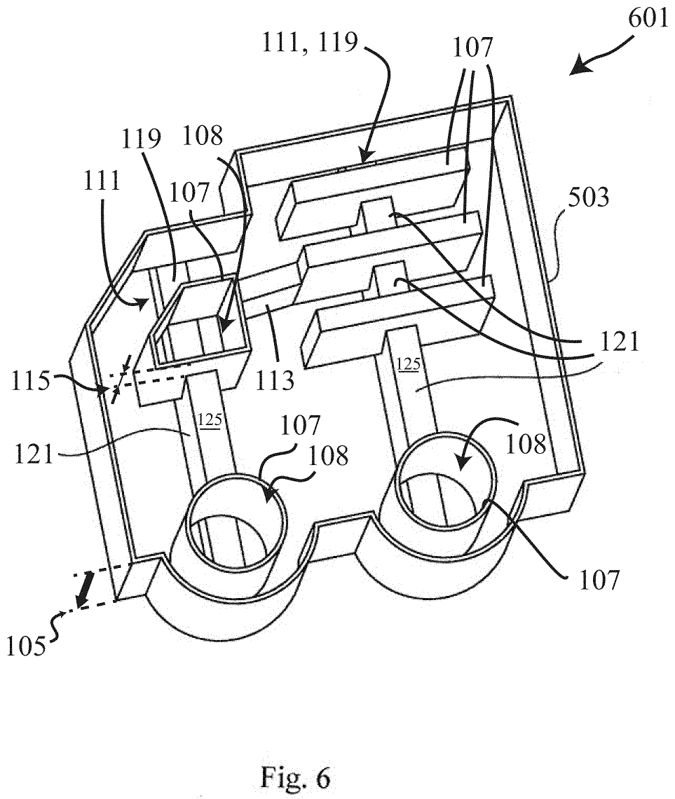

With respect to the combined members 111 (all of the “canal members” of FIGS. 2 and 4 are canal-member-like-portions of the combined members 113), the “canal members”-like portions 121 are contiguous with the “locator members”-like portions 119, and are thereby combined members that have a marginal thickness 123 proximate the maximum fill height 105, defining a lower face 125 (FIGS. 4 and 6) that is above the canal formation height 115, along portions that extend between the mold wall 103 to a first volume 107. Thereafter, the combined members 113 extend a “canal member”-like 121 portion from that “first” volume 107 to a second volume 107.

These canal member-like portions 121 comprise an increased thickness 123 extending ˜downward-from˜ or ˜below˜ the maximum fill height 105, defining a lower face 125, proximate the canal formation height 115. This means that the combined members 113 are therefore characterizable as either a type of locator member or a canal member, before the narrowing aspect of having the characteristics of both locator members and canal members.

Note: because there are merely portions along the locator members 109 (otherwise only having marginal thickness proximate the maximum fill height) that could have an increased thickness, in order to provide canal members, the present invention does contemplate exemplary embodiments which teach that embodiments comprising locator members 109 could be augmented or modified (though steps for modification and features to provide such additional function are not shown here), in order to provide a canal formation height 115, without any other modifications.

Referring now to FIG. 10, what is shown is a perspective view of a truck-shaped unit 1001 of pourable material formed with a pancake mold embodiment similar to mold 601 of FIGS. 6 (and 9A-B), having a truck shaped mold wall 503 with canal members 113 (and canal-member-function-providing combined members 111), in accordance with the present disclosure.

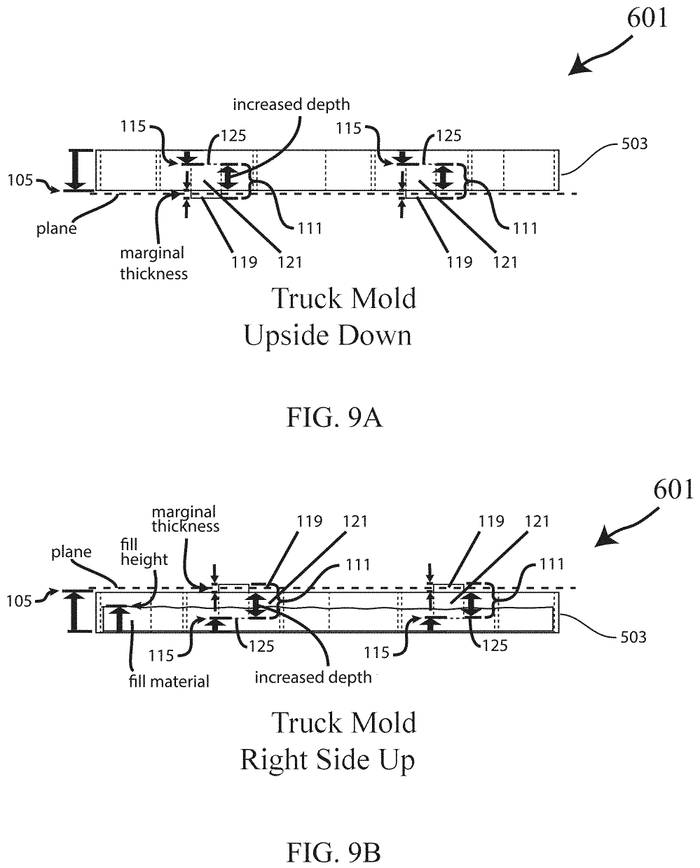

To produce the unit 1001 with a mold similar to mold 601, such exemplary mold devices contemplate that pouring a fill material into the device 601 to a fill height (903, FIG. 9B) that is greater than the canal formation height 115 and less than the maximum fill height 105 defines a contiguous unit 1001 of fill material having a periphery in the shape of the peripheral boundary 503; windows or window voids 1003 in the material or unit 1001 at the locations of the exclusion volumes (107, FIGS. 5-6) through the entire height 1005 of the unit 1001 and having canals 1007 extending between the windows 1003 through the amount or fraction or portion of the height 1005 which is between the canal formation height 105 and the fill height 117 (FIGS. 9A-B) (or as corresponds to the heightwise position between the canal formation height 105 and the fill height 117, with respect to the corresponding heights of these features at the time of pouring the fill material into the mold 601, in the case of referring to a unit 1001 that experienced a height transformation following pouring, such as a pancake batter rising within a mold before fixation of such features as the canals 1007).

In all of the exemplary embodiments of FIGS. 1-(9A-B), the walls (103, 303, 503, 703), volumes (107), and members (109, 111, 113) are materially contiguous, and comprise a mold structure material selected from a list comprising silicone, rubber, cast iron, and food safe plastic and food safe metal configured to heat-deformation resistance in a temperature range suitable for cooking food, though these are not necessarily required of all embodiments. The present invention also contemplates ones in which the molds may comprise more than one material or which comprise more than one sub-assembly, such that the other limitations of the invention's exemplary embodiments may be achieved, but merely do not require a single-piece construction.

For example, not shown are contemplated exemplary embodiments in which an upper and lower mold coordinate to form an enclosure that could limit fill material against movement from escaping the shape of the various mold walls and exclusion voids by pouring the fill material over canal members which fit between exclusion voids with such a 2-piece mold arranged in a configuration more akin to the “upside down” arrangement of FIG. 9A.

Referring back to FIGS. 5 and 6, the peripheral boundary comprises the shape of the silhouette of a wheeled vehicle, a commercial truck (according to the shape of the mold wall 503 in FIGS. 5 and 6), and the exclusion volumes 107 are configured to produce at least one void, that is a vehicle window void 1025, one having the shape of a vehicle window of such a vehicle. Some examples of descriptors of such vehicle shapes and roughly describing similarly useful but potentially varying shapes are selected from a list comprising a two-box shipping truck, a blunt-front-cab commercial truck, and a moving truck.

Beyond the fun aspects of such exemplary device embodiments of the present invention, the present invention contemplates embodiments configured to control and represent the behavior and apparent flow aspects of a liquid 1027 poured into a unit formed by an exemplary mold with respect to, and particularly with respect to observation of embodiments with canal members 113 that appear in FIGS. 6 and 8 (specifically, unit 1001, FIGS. 10 and 11C).

Referring now to FIG. 10, what is shown is a perspective view of the underside of a truck-shaped pancake formed with a pancake mold embodiment having a truck shaped mold wall with canal members in accordance with the present disclosure. The pancake is a unit of fill material 1001 formed by a device embodiment of the present invention that is similar to 601, the truck mold wall being similar to 503, the canal members being ones similar to 113.

The peripheral boundary comprises the shape of the silhouette of a wheeled vehicle, and the exclusion volumes 107, FIG. 6 of the mold 603 are configured to produce window voids 1003 that are vehicle-window-shaped-window voids 1025, ones having the shape of vehicle windows of such a wheeled vehicle.

the underside of unit 1001 can be seen to have a continuous flow route 1009 (indicated by arrow labeled 1009) between the truck's window void 1025, and the middle of the three elongate window voids 1019.

Referring now to FIGS. 11A-D, what is shown are several top-side perspective views of exemplary units of fill material produced with exemplary mold The units 1001 1101, 1103 of fill material 1029 (see also FIG. 9B) are configured to receive a poured liquid 1027 into a first window void 1003 (here, the vehicle-window-shaped void 1025), as a master fill window void 1017 and thereafter effect flow of the liquid 1027 through the canal 1007, into the second window void 1003, an elongate progress bar window 1021.

Specifically, the elongate progress-bar window void(s) 1021 shown have a length 1103 characterized by a proximal end 1105 and a distal end 1107 and a canal 1007 directly connecting the master fill window void 1017 to the progress-bar window void 1021, wherein at least one of the master filler window void 1017, progress-bar window void 1021, and canal 1007 are sized and shaped with respect to a liquid's (1027's) flow properties. Each of the units 1001, 1101, 1003, is thereby configured to receive the liquid 1027 at a desired rate of pouring into the master fill window void 1017 and effect flow of the liquid 1027 into the progress bar window void 1021, such that the progress bar window void 1021 fills uniformly with the liquid 1027 across its width 1028, proximate the proximal end 1105 and then progressively fills along the length 1103 from the proximal end 1105 to the distal end 1107 at a rate of filling that approximately corresponds to the rate of pouring.

In at least one contemplated embodiment similar to those shown in FIGS. 11A-D, the unit is further configured with respect to the flow properties of the liquid 1027 that flow of the liquid from the first void (master fill window void 1017), through the canal 1007, into the progress-bar window void 1021 are also configured with respect to the properties of the fill material 1029 that flow 1009 experiences mitigable absorption of the liquid 1027 into the fill material 1029, to promote filling of the progress bar window void 1021 (as well as other window voids 1003, 1019, 1023) with the liquid 1027 before excess absorption of the liquid into the fill material occurs. Such a configuration enhances the embodiment by effecting distribution of the liquid to across the unit 1001, 1101, 1003, such that as absorption occurs, the liquid will more evenly permeate the unit. Specifically, in the case of units using a pancake batter or similar for its fill material 1029, and a liquid 1027 desirable for use with a pancake, such as syrup, configuring the voids and/or canals 1007 would benefit the composition of the unit 1001, 1101, 1003, as a rate of syrup flow across the pancake that effects good distribution before absorption progresses significantly would subsequently effect a more uniform absorption, resulting in a pancake with a more uniform flavor, texture, and moisture content throughout.

Also shown among the voids 1003 in FIGS. 10 and 11A-D are wheel-shaped window voids 1023.

FIGS. 11A and 11B additionally comprise an elongate window void 1019 spatially arranged in parallel to the elongate progress bar window void 1021. For clarity of the above-emphasized flow behaviors, canals that could depict a flow route to this elongate window void 119 are omitted.

Referring now to FIG. 11C, what is shown is a perspective view of the top-side of the unit 1001 that is similar to FIG. 10. Unit 1001 demonstrates that a device embodiment configured to produce such a unit (such as 601, FIG. 6) is configured to produce elongate window voids 1019 comprising ones which fill via canals 1007 from the progress-bar-window 1021, arranged in spatially-parallel, but depending fashion, with respect to order of receiving liquid 1027, and from locations on the progress bar window void 1021 in symmetric arrangement about the progress bar window void 1021, such that the uniformity of the progress of the liquid 1027 along the length 1103 (FIG. 11A) of the progress-bar-window 1021 is maintained uniformly across its width while the liquid is poured at the rate of pouring.

Referring now to FIG. 11D, what is shown is a top-side view of a unit 1103 of fill material 1029 configured to effect flow in plural parallel flow routes into plural elongate progress bar window voids 1021 via dedicated canals 1007 for each of these voids 1021. The present invention contemplates several alternative embodiments that are configured to effect a rate of filling corresponding to a particular rate of pouring, such as ones which effect the same rate of filling for all of the voids 1021, and ones in which the rates of filling for each of the voids 1021 are proportionally slower or faster than the others of the voids 1021.

[come back to claims 14,15,16 . . . maybe should be described before FIG. 11E]

Referring now to FIG. 11E, what is shown is a mold 1113 having similar elements to those of mold device embodiment 601, but which comprises plural canal members 113 connecting the exclusion volume 107 associated with the formation of the master fill window void (1017, FIG. 11D) independently to each of the exclusion volumes 107 associated with the formation of each of the elongate progress bar window voids (1021, FIG. 11D).

Referring now to FIG. 11F, what is shown is a close perspective view of a unit 1115 of fill material 1029 having a vehicle-window-shaped-void 1025, and an island unit 1109 of fill material 1029 located within the void 1025 and having a size and shape similar to the periphery shape of the void 1025, such that the void 1025 and island unit 1109 define a boundary window void 1111 of marginal thickness. This unit 1115 is the product of a mold device having exclusion volumes 107 that comprises an island-formation volume (108, FIGS. 1-8).

The island-formation volume 108 is an open space within the peripheral boundary of the particular exclusion volume 107, such that the exclusion volume 107 comprises only a marginal thickness, such that the mold device in question is configured to receive fill material 1029 into the island-formation volumes 108 (in addition to receiving material into mold, outside the peripheral boundary of the exclusion volumes 107) to produce this unit 1115, comprising a window void 1003 with a boundary shape similar to the peripheral boundary of the particular exclusion volume 107, as well as an island unit 1109 having a peripheral boundary of the same boundary shape and approximate size, such that the two units 1109 and 1115 thereby define a boundary window void 1111.

The following are common to both FIGS. 1-2

Referring now to FIGS. 1-2, what is shown are perspective view of an exemplary pancake mold of the present invention having a butterfly shaped mold wall. The following are common to both FIGS. 1-2:

A butterfly shaped mold 101, including the peripheral wall 101. There are several exclusion volumes 103 and 105.

Referring specifically now to FIG. 2, what is shown is a perspective view of an embodiment of a pancake mold embodiment having a butterfly shaped mold wall 101 with canal members in accordance with the present disclosure.

Referring now to FIG. 3, what is shown is a perspective view of an embodiment of a pancake mold embodiment having a heart shaped mold wall in accordance with the present disclosure.

Referring now to FIG. 4, what is shown is a perspective view of an embodiment of a pancake mold embodiment having a heart shaped mold wall with canal members in accordance with the present disclosure.

Referring now to FIG. 5, what is shown is a perspective view of an embodiment of a pancake mold embodiment having a truck shaped mold wall in accordance with the present disclosure.

Referring now to FIG. 6, what is shown is a perspective view of an embodiment of a pancake mold embodiment having a truck shaped mold wall with canal members in accordance with the present disclosure.

Referring now to FIG. 7, what is shown is shows a perspective view of an embodiment of a pancake mold embodiment having a sun shaped mold wall in accordance with the present disclosure.

Referring now to FIG. 8, what is shown is a perspective view of an embodiment of a pancake mold embodiment having a sun shaped mold wall with canal members in accordance with the present disclosure.

Referring now to FIGS. 9A-B, what is shown are side elevation views of an embodiment of a pancake mold embodiment having a truck shaped mold wall with canal members in accordance with the present disclosure.

Referring now to FIG. 10, what is shown is a perspective view of a truck-shaped pancake formed with a pancake mold embodiment having a truck shaped mold wall with canal members in accordance with the present disclosure.

Not shown is another exemplary contemplated embodiment in accordance with the present invention, which is adequately disclosed here by being conceptually similar to those embodiments shown in FIGS. 11A-F, as to progress-bar-like window voids, as could be applied to the sun-shaped embodiments shown in FIGS. 7 and 8.

The embodiment comprises a plurality of voids that include progress-bar window voids arranged such that they are distributed with their proximal ends distributed circumferentially about the master fill window and the lengths of each of the respective progress-bar window voids extends radially away from the master fill window. The master fill window and progress-bar windows are shaped to resemble a round sun surrounded by a radially-extending array of rays of sunshine.

Thereby, such an embodiment is configured to produce a flow of liquid to the progress bars in response to a rate of pouring that exceeds the peak flow rate of the master window and canals, such that the pooling and subsequent distribution of the liquid approximates the phenomena of the changing in apparent intensity and uniformity of light in one of the eyes of someone looking up at the sun and an automatically adjusting camera.

Specifically, to elaborate as to how one exemplary embodiment could approximate such behavior of an automatically adjusting camera or a person's eyes adjusting to looking at the sun, the embodiment would effect behavior in distributing liquid into a mold, particularly where the rate of pouring was in excess of the ideal rate of pouring for a master fill window void, in the way that adjustments are made to transition between a bright view with overwhelming intensity of light, with respect to the overall contrast in ambient light across the entire surrounding areas to the sun, as would occurs with initial looking-upon the sun overwhelms as a central point of light of high contrast with surrounding areas, and progressive decreasing of iris, aperture, or sensor sensitivity or exposure time or rate or software adjustment for contrast correspondingly appears as the quantity of light or proportion of liquid at the center spreading out and then appearing in some quantity at a distance from the original central point of overwhelming intensity or density.

In particular, because mold 801 comprises the large circular exclusion volume 107, it is configured to produce a unit of fill material that would comprise a void suitable to function as a master fill window void, in the manner of the master fill window void 1017 (FIGS. 10,11A-D), in the middle of such a unit. The particular round volume 107 in the center of mold 801 is connected circumferentially by a circular array of individual canal-forming members 113 dedicated to the respective individual exclusion members (resembling rays of sunshine) 107 radially-extending-therefrom. The resulting unit would thereby comprise canals connecting to a proximal end of an elongate progress bar window void, such that pouring a liquid into the master fill window void would cause the liquid to flow through the respective canals into the progress bar window voids, fill the width thereof, and then proceed along the length of the elongate void, to a distal end of the void, at the end of the length. Also, similarly to the multiple-progress-bar-window-voids 1021 of FIG. 11D, the flow would occur in parallel, and the rate of filling each would correspond at some desired rate, or even identical rate to one another, to a rate of pouring the liquid into the round master fill window void.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

1. A device comprising:
a peripheral mold wall defining a peripheral boundary and a maximum fill height;
a plurality of exclusion volumes offset from the mold wall within the peripheral boundary;
a plurality of locator members connecting the volumes with respect to the mold wall, extending in a plane proximate the maximum fill height, defining the locations of the volumes within the boundary; and
a plurality of canal members connecting the volumes and defining a canal formation height that is lower than the maximum fill height,
such that pouring a fill material into the device to a fill height that is greater than the canal formation height and less than the maximum fill height defines a contiguous fixable unit of material having a periphery in the shape of the peripheral boundary; window voids in the material at the locations of the exclusion volumes through the entire height of the unit and having canals extending between the voids through the amount of the height which is between the canal formation height and the fill height.

2. The device of claim 1, wherein:
the fill material is a batter selected from a list comprising pancake batter and waffle batter.

3. The device of claim 1, wherein:
the wall, volumes, and members are materially contiguous, and comprise a mold structure material configured to heat-deformation resistance in a temperature range suitable for cooking food, one selected from a list comprising silicone, rubber, cast iron, and food safe plastic and food safe metal.

4. The device of claim 1, wherein:
the peripheral boundary comprises the shape of the silhouette of a wheeled vehicle, and the exclusion volumes are configured to produce window voids having the shape of vehicle windows of such a wheeled vehicle.

5. The device of claim 4, wherein:
the peripheral boundary has the shape of a commercial truck one selected from a list comprising a two-box shipping truck, a blunt-front-cab commercial truck, and a moving truck.

6. The device of claim 1, wherein:
the peripheral boundary comprises the shape of the silhouette of a wheeled vehicle, and the exclusion volumes are configured to produce window voids having the shape for the wheels selected from a list comprising wheels within tires, hub cabs within tires, and concentric bores within tires.

7. The device of claim 1, wherein:
the windows and canals are configured such that pouring a liquid into a first window void selected from the window voids effects flow of the liquid into a canal, such that the liquid flows into a second window void.

8. The device of claim 7, wherein:
the windows and canals are configured in size, shape, and proximity such that flow of the liquid from the first window void into the second window void through a canal occurs with mitigable absorption into the fill material, to promote filling of the window voids with the liquid before excessive absorption of the liquid into the fill material.

9. The device of claim 8, and wherein:
the exclusion volumes comprise island-formation volumes, an island-formation volume being ones that comprises an open space within the peripheral boundary of the particular exclusion volumes, such that the exclusion volume comprises only a marginal thickness,
such that the device is configured to receive fill material into the island-formation volumes to produce a unit comprising a window void with a boundary shape similar to the peripheral boundary of the exclusion volume, and an island unit having a boundary of the same boundary shape within the window, the two units thereby defining a boundary window void.

10. The device of claim 1, and wherein the exclusion volumes and canal members are configured in an amount and relative location to effect the unit of fill material with:
a master filler window void;
an elongate progress-bar window void having a length characterized by a proximal end and a distal end; and
a canal connecting the master filler window to the progress-bar window void;
wherein at least one of the master filler window void, progress-bar window void, and canal are sized and shaped with respect to a liquid's flow properties, such that the unit is configured to receive the liquid at a rate of pouring into the master filler window and effect flow of the liquid into the progress bar window, such that the progress bar window fills uniformly across its width proximate the proximal end and then progressively fills along the length from the proximal end to the distal end at a rate of filling that approximately corresponds to the rate of pouring.

11. The device of claim 10, wherein the device is configured to produce a unit of material that comprises a plurality of progress-bar windows.

12. The device of claim 10, wherein the device is configured to produce a plurality of elongate windows, the progress-bar window being among the elongate windows.

13. The device of claim 12, wherein the device is configured to produce elongate window voids comprising ones which fill via canals from the progress-bar-window, arranged in parallel depending fashion, such that the uniformity of the progress-bar-window is maintained across its width while the liquid is poured at the rate of pouring.

14. The device of claim 11, wherein the plurality of voids comprise progress-bar window voids arranged such that they are distributed with their proximal ends distributed circumferentially about the master fill window and the lengths of each of the respective progress-bar window voids extends radially away from the master fill window.

15. The device of claim 14, wherein the master fill window and progress-bar windows are shaped to resemble a round sun surrounded by a radially-extending array of rays of sunshine.

16. The device of claim 14, wherein the device is configured to produce flow of liquid progress to the progress bars in response to a rate of pouring that exceeds the peak flow rate of the master window and canals, such that the pooling and subsequent distribution of the liquid approximates the phenomena of the changing in apparent intensity and uniformity of light in one of the eyes of someone looking up at the sun and an automatically adjusting camera.

17. The device of claim 1, and wherein the locator members comprise at least one combined locator and canal member, the combined member extending with marginal thickness proximate the maximum fill height defining a lower face that is above the canal formation height, from the mold wall to a first volume, and thereafter extending from the first volume to a second volume with an increased thickness below the maximum fill height defining a lower face proximate the canal formation height.

18. The device of claim 9, wherein the exclusion volumes comprise island-formation volumes, island-formation volumes being ones comprising only a marginal thickness inwardly-extending from the outermost footprint boundary of the particular volume, such that the device is configured to receive additional fill material by pouring into the island-formation volumes to produce a unit comprising a window and with a boundary shape and an island unit having a boundary of the same boundary shape within the window and thereby defining a boundary window void.

19. A method of forming a unit of poured fill material, comprising:
defining a peripheral boundary and a maximum fill height with a peripheral mold wall;
offsetting a plurality of exclusion volumes from the mold wall within the peripheral boundary;
connecting the volumes with respect to the mold wall and defining the locations of the volumes within the boundary with a plurality of locator members, extending in a plane proximate the maximum fill height; and
connecting the volumes and defining a canal formation height that is lower than the maximum fill height with a plurality of canal members,
pouring a fill material into the device to a fill height that is greater than the canal formation height and less than the maximum fill height to define a contiguous fixable unit of material having a periphery in the shape of the peripheral boundary; window voids in the material at the locations of the exclusion volumes through the entire height of the unit and having canals extending between the voids through the amount of the height which is between the canal formation height and the fill height.

20. The method of claim 19, and further comprising:
pouring a liquid into a first void of the plurality of voids of the unit to effect a flow from the first void into a canal to a second void of the plurality of voids, such that such that flow of the liquid from the first window void into the second window void through a canal occurs with mitigable absorption into the fill material, to promote filling of the window voids with the liquid before excessive absorption of the liquid into the fill material.
